(19) United States
(12) Patent Application Publication
(10) Pub. No.: US 2008/0134905 A1
(43) Pub. Date: Jun. 12, 2008

(54) SELF-STIRRING COOKWARE

(76) Inventor: Zheng Peng, Ypsilanti, MI (US)

Correspondence Address: ZHAOXIA XU, 4694 SYCAMORE DR., YPSILANTI, MI, 48197, US

(21) Appl. No.: 11/608,486

(22) Filed: Dec. 8, 2006

(51) Int. Cl. A47J 43/04; B65D 25/28

(52) U.S. Cl. 99/348; 220/752

(57) ABSTRACT

A self-stirring cookware (100). Cookware (100) comprises a container (102) having a open top and a sidewall for holding food, a lid (104) for closing the open top of container (102), a stirrer (108) installed inside container (102) for stirring food, and a co-rotation prevention device (110) installed inside container (102) on the sidewall of container (102) for preventing food pieces from co-rotating with stirrer (108), as stirrer (108) rotates.

### TECHNICAL FIELD AND INDUSTRIAL APPLICABILITY OF THE INVENTION

This invention generally relates to cookware. More specifically, this invention relates to self-stirring cookware.

### BACKGROUND OF THE INVENTION

Traditional cookware has a container for holding food and a handle for use of handling the container. When cooking, people have to stir food to facilitate heat transfer and uniform heating. Such cooking techniques include stir-frying, sautéing, braising, simmering, etc.; which require skill and labor.

U.S. Pat. No. 6,845,707, issued to Xu, et al., on Jan. 25, 2006, teaches regarding an automatic cooking apparatus having a stirrer installed inside an inner pan for automated stirring and cooking. Since the stirrer rotates around a vertical axis, food inside the inner pan tends to co-rotate with the stirrer, as the stirrer rotates; which diminishes the effectiveness of the stirrer. Without proper stirring, food cannot be ideally cooked.

A solution to the issue is to add a co-rotation prevention feature to the sidewall of the container. A small portion of the sidewall protrudes inward laterally to a predetermined distance. The protrusion portion of the sidewall of the container extends generally vertical, from the upper portion of the sidewall downward to a predetermined height. However, this design is not effective in preventing food co-rotation. The protrusion cannot go inward far enough to realize optimum performance due to manufacturing limitations. This is increasingly amplified when cooking pans have large diameters.

Therefore, it remains desirable to provide a self-stirring cookware having an innovative co-rotation prevention mechanism that minimizes food co-rotation with the stirrer, as the stirrer rotates.

### BRIEF SUMMARY OF THE INVENTION

Accordingly, the present invention is a self-stirring cookware. This self-stirring cookware comprises a container having an open top and a sidewall for holding food, a lid for closing up the open top of the container, a stirrer installed inside the container for stirring food, and a co-rotation prevention device installed on the sidewall of the container for preventing food co-rotation with the stirrer, as the stirrer rotates.

Accordingly, the followings are some of the objects, features, and advantages of the present invention.

It is an object of the present invention to provide a self-stirring cookware, which can be used with a cooking platform that has a heating device and a power-drive system.

It is another object of the present invention to provide a self-stirring cookware that is highly effective in stirring food.

It is a feature of the present invention that this self-stirring cookware includes a co-rotation prevention device installed on the sidewall of the container for minimizing food co-rotation with the stirrer, as the stirrer rotates.

It is another feature of the present invention that the co-rotation prevention device includes an elongated member having an end installed on the sidewall of the container. The elongated member extends inward to a predetermined distance, away from the sidewall of the container, and further extends downward to a predetermined height, above the stirrer.

It is an advantage of the present invention that the co-rotation prevention device can significantly reduce food co-rotation with the stirrer, as the stirrer rotates, such that food can be effectively stirred for uniform heating and for efficient heat transfer.

Further more features and advantages of the present invention will be readily appreciated, as the same becomes better understood after reading the subsequent description when considered in connection with the accompanying drawings.

### BRIEF DESCRIPTION OF THE DRAWING

FIG. 1 illustrates a cross-sectional view of an embodiment of the present invention, a self-stirring cookware 100.

FIG. 2 illustrates an exploded cross-sectional view of stirrer 108.

FIG. 3 illustrates an exploded cross-sectional view of seal device 130.

FIG. 4 illustrates an exploded cross-sectional view of an alternative design of seal device 130.

FIG. 5 illustrates a perspective view of an alternative design of co-rotation prevention device 110, a co-rotation prevention device 140.

### DETAILED DESCRIPTION OF THE INVENTION

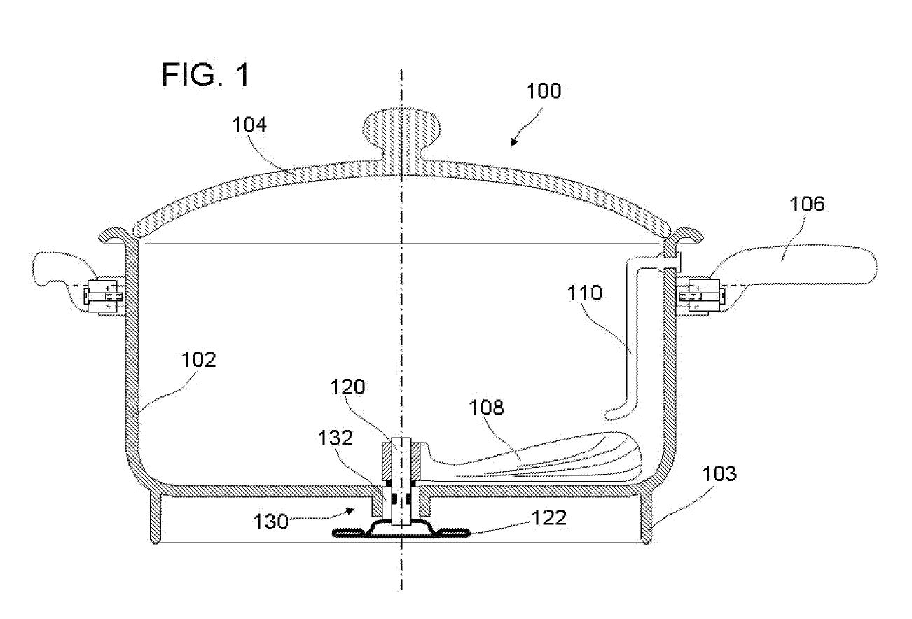

Reference is made to FIG. 1, which illustrates a cross-sectional view of an embodiment of the present invention, a self-stirring cookware 100.

A container 102, having an open top, a sidewall, and a central aperture on the bottom, is provided for holding food. Container 102 is, preferably, coated with a non-stick material. A supporting leg or rim 103 extending from the bottom of container 102 downward to a predetermined distance, such that container 102 can stand on a horizontal countertop. The bottom of container 102 is disposed and adapted to rest on a heating device (not shown) for heating food.

A lid 104 is provided for closing up the open top of container 102. Lid 104 can be made of a transparent material, or a metal material, but has an observation window (not shown), made of a transparent material, for observing cooking processes by users.

A handle 106 is fixedly installed on the upper portion of the sidewall of container 102 for use of handling container 102.

A stirrer 108 rotatably and removably installed inside container 102, is provided for stirring food.

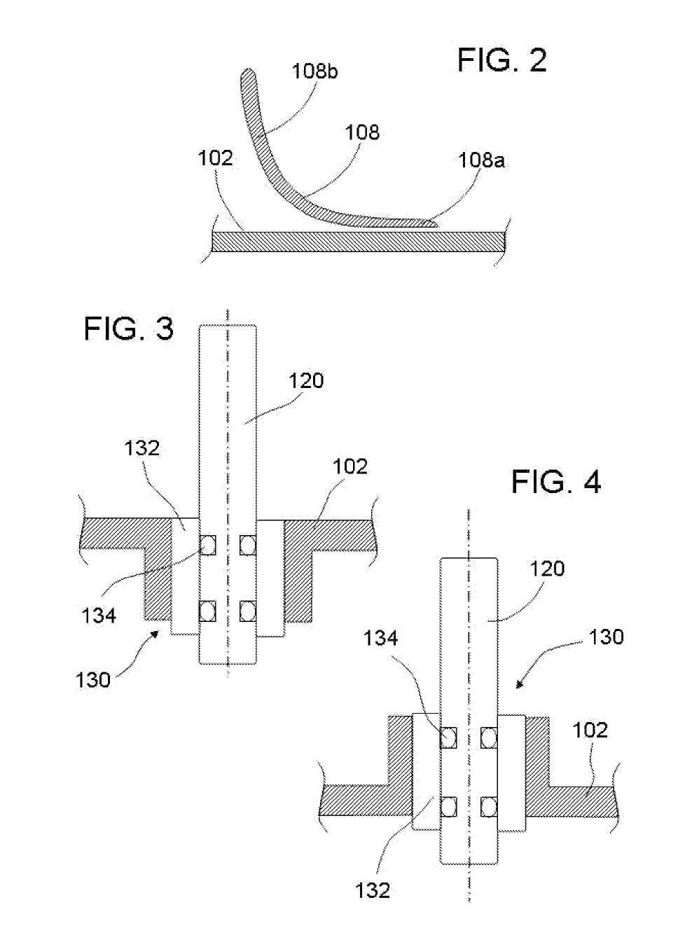

FIG. 2 illustrates a cross-sectional view of stirrer 108 in relation to the bottom of container 102. The cross-section of stirrer 108 generally forms a plow-like configuration. The front portion thereof generally designated as 108a, is close to the bottom of container 102 with a small predetermined clearance for scooping up food pieces. The rear portion thereof, generally designated as 108b, extending gradually upward, serves for lifting up/turning over food pieces. The clearance between front portion 108a and the bottom of container 102 is minimized for ideal performance.

However, as stirrer 108 rotates, it tends to push food forward, resulting in food co-rotation, especially when stirrer rotates at a lower rotation speed and container 102 is large in diameter. Food co-rotation diminishes the effectiveness of stirrer 108.

Reference is, again, made to FIG. 1. A co-rotation prevention device 110 is installed inside container 102, on the sidewall of container 102, for preventing food pieces from co-rotating with stirrer 108, as stirrer 108 rotates.

Device 110 includes an elongated member and extends generally vertical along the sidewall of container 102. The upper end of device 110 is installed on the upper portion of container 102 and disposed preferably close to handle 106, such that device 110 would not obstruct food unloading. Device 110 extends inward to a predetermined distance, away from the sidewall of container 102, and then further extends downward to a predetermined height, above stirrer 108. The clearance between the vertical portion of device 110 and the sidewall of container 102 is predetermined by the size of container 102 and the desired easiness of cleaning of device 110 and container 102. When food co-rotates with stirrer 108 and runs against device 110, as stirrer 108 rotates, the food pieces at a higher level would be stopped and tumble down due to gravity, resulting in better mixing or stirring of food, thereby facilitating heat transfer to and uniform heating of food.

A drive shaft 120 is threaded through the central aperture on the bottom of container 102. The upper portion of shaft 120 is engaged with stirrer 108. A coupling element 122 is installed on the lower portion of shaft 120. Coupling element 122 is provided for removably engaging an outside power-drive system (not shown).

A seal device 130 is provided for sealing between shaft 120 and the bottom of container 102, as shown in FIG. 3, which illustrates an exploded cross-sectional view of seal device 130. Seal device 130 is installed on the bottom of container 102 and comprises a bushing 132 and packing 134.

Bushing 132 is co-axial to shaft 120. Packing 134 is imbedded inside a groove cut around shaft 120. A plurality of packing 134 can be provided for more reliable sealing, as known to those skilled in the art. When inserted into bushing 132 together with shaft 120, packing 134 is compressed and squeezed against shaft 120 and bushing 132 to create a seal.

Materials for packing 134 are extremely important when selecting the proper packing for an application. Basic requirements include heat resistance, wearing resistance, elasticity, etc.

Seal device 130 can, alternatively, take many other forms, such as bushing, labyrinth seals, or combinations of multiple forms for ideal performance, as known to those skilled in the art and suggested by this invention disclosure.

FIG. 4 illustrates an exploded cross-sectional view of an alternative design of seal device 130 of FIG. 3. In this alternative design, seal device 130 is installed inside container 102 on the central bottom thereof, instead of being installed outside container 102. Bushing 132 extends upward to a predetermined height above the bottom of container 102, such that packing 134 is disposed above the bottom of container 102.

There is an important advantage of the alternative design illustrated in FIG. 4. For most applications, seal device 130 is disposed at a higher position above the bottom of container 102, such that the sealing surface is not immersed in cooking oil or hot liquid. Therefore, the requirement on seal device 130 is significantly reduced.

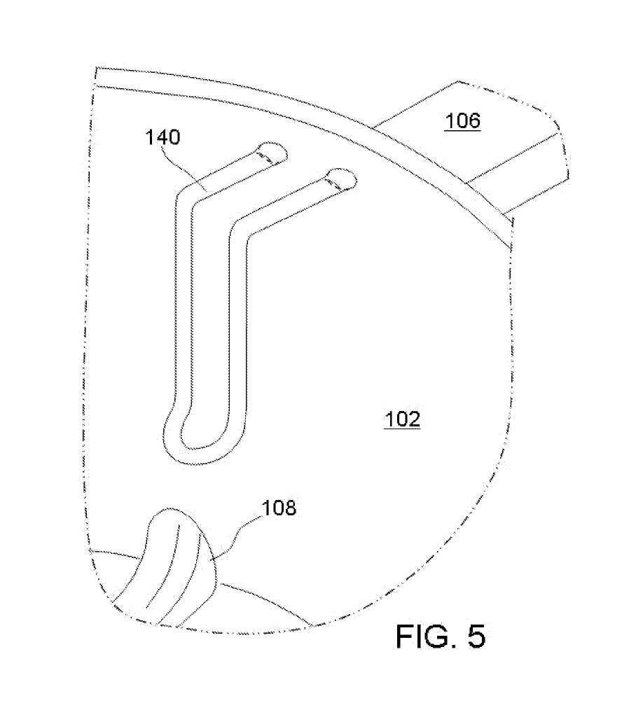

Reference is made to FIG. 5, which illustrates a perspective view of an alternative design of co-rotation prevention device 110, a co-rotation prevention device 140.

Device 140 includes an elongated member having both ends installed on the sidewall of container 102, side by side with a predetermined clearance between each other. Device 140 is preferably disposed close to handle 106, such that device 140 would not obstruct food unloading. Device 140 extends inward to a predetermined distance, away from the sidewall of container 102, and then further extends downward to a predetermined height, above stirrer 108. The clearance between the vertical portion of device 140 and the sidewall of container 102 is predetermined by the size of container 102 and the desired easiness of cleaning of device 140 and container 102.

Accordingly, readers will see that this self-stirring cookware of the present invention can be used with a heating device and a power-drive system to perform automatic stirring and cooking. Testing has shown superior performance of the unique co-rotation prevention mechanism disclosed in this invention disclosure. The co-rotation prevention device is simple to use and inexpensive to manufacture.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

What is claimed is:

1. A self-stirring cookware, said self-stirring cookware comprising:
a container having an open top and a sidewall for holding food;
stirring means installed inside said container for stirring food;
co-rotation prevention means installed inside said container on the sidewall of said container for preventing food pieces from co-rotating with said stirring means, as said stirring means rotates;
wherein said co-rotation prevention means includes an elongated member having an end installed on the sidewall of said container;
wherein said elongated member extends inward to a predetermined distance, away from the sidewall of said container; and
wherein said elongated member further extends downward to a predetermined height, above said stirring means.

2. A self-stirring cookware as defined in claim 1, wherein said self-stirring cookware further includes a handle installed on the sidewall of said container for use of handling said container.

3. A self-stirring cookware as defined in claim 2, wherein said co-rotation prevention means is installed substantially close to said handle, whereby said co-rotation prevention means would not obstruct food unloading.

4. A self-stirring cookware, said self-stirring cookware comprising:
a container having an open top and a sidewall for holding food;
stirring means installed inside said container for stirring food;
co-rotation prevention means installed inside said container on the sidewall of said container for preventing food pieces from co-rotating with said stirring means, as said stirring means rotates;
wherein said co-rotation prevention means includes an elongated member having a first end and a second end;
wherein said first end and said second end are installed side by side on the sidewall of said container, with a predetermined clearance between each other;
wherein said elongated member extends inward to a predetermined distance, away from the sidewall of said container; and
wherein said elongated member further extends downward to a predetermined height, above said stirring means.

5. A self-stirring cookware as defined in claim 4, wherein said self-stirring cookware further includes a handle for use of handling said container.

6. A self-stirring cookware as defined in claim 5, wherein said co-rotation prevention means is installed substantially close to said handle, whereby said co-rotation prevention means would not obstruct food unloading.

7. A self-stirring cookware, said self-stirring cookware comprising:
a container having an open top, a sidewall, and a central aperture on the bottom thereof for holding food;
stirring means installed inside said container for stirring food;
a drive shaft threaded through the central aperture on the bottom of said container and engaged with said stirring means for driving said stirring means;
sealing means for sealing the interface between the bottom of said container and said drive shaft;
co-rotation prevention means installed inside said container on the sidewall of said container for preventing food pieces from co-rotating with said stirring means, as said stirring means rotates;
wherein said co-rotation prevention means includes an elongated member having an end installed on the sidewall of said container;
wherein said elongated member extends inward to a predetermined distance, away from the sidewall of said container; and
wherein said elongated member further extends downward to a predetermined height above said stirring means.

8. A self-stirring cookware as defined in claim 7, wherein said sealing means includes a sealing packing adapted to seal the interface between said drive shaft and the bottom of said container.

9. A self-stirring cookware as defined in claim 7, wherein said sealing means is installed on the bottom of said container and disposed underneath the bottom thereof.

10. A self-stirring cookware as defined in claim 9, wherein said sealing means includes a seating packing adapted to seat the interface between said drive shaft and the bottom of said container.

11. A self-stirring cookware as defined in claim 7, wherein said sealing means is installed on the bottom of said container, disposed inside said container, and extended upward to a predetermined height above the bottom of said container, whereby the requirement on said seating means is significantly reduced.

12. A self-stirring cookware as defined in claim 11, wherein said sealing means includes a seating packing adapted to seat the interface between said drive shaft and the bottom of said container.

13. A self-stirring cookware as defined in claim 7, wherein said self-stirring cookware further includes a handle for use of handling said container.

14. A self-stirring cookware as defined in claim 13, wherein said co-rotation prevention means is installed substantially close to said handle, whereby said co-rotation prevention means would not obstruct food unloading.

15. A self-stirring cookware as defined in claim 7, wherein said sealing means includes a bushing member for supporting said drive shaft.

16. A self-stirring cookware as defined in claim 15, wherein said sealing means includes a sealing packing adapted to seal the interface between said drive shaft and said bushing member.

17. A self-stirring cookware as defined in claim 7, wherein said self-stirring cookware further includes a coupling element installed on the lower portion of said drive shaft for removably engaging an outside power-drive system.

18. A self-stirring cookware as defined in claim 17, wherein said container includes a supporting leg or rim extending from the bottom of said container downward to a predetermined distance beyond the vertical height of said coupling element, such that said self-stirring cookware can stand on a horizontal counter top.

19. A self-stirring cookware as defined in claim 7, wherein said self-stirring cookware further includes a lid for closing up the open top of said container.
